(19) United States
(12) Patent Application Publication
(10) Pub. No.: US 2005/0088937 A1
(43) Pub. Date: Apr. 28, 2005

(54) METHOD FOR DETERMINING EXISTENCE OF AN OPTICAL DISK IN AN OPTICAL DISK DRIVE

(76) Inventor: Chien-Li Hung, Taipei City (TW)

Correspondence Address: NORTH AMERICA INTERNATIONAL PATENT OFFICE (NAIPC), P.O. BOX 506, MERRIFIELD, VA, 22116, US

(21) Appl. No.: 10/711,947

(22) Filed: Oct. 14, 2004

(30) Foreign Application Priority Data
Oct. 24, 2003 (TW) 092129681

(51) Int. Cl. G11B 7/00

(52) U.S. Cl. 369/53.2; 369/44.27

(57) ABSTRACT

This present invention discloses a method for determining existence of a disk in an optical disk drive. Instead of using an optical pick-up head with a single laser wavelength, an optical pick-up head equipped with two different laser wavelengths is utilized to complete the determination of existence of a disk in an optical disk drive. Among the determining procedures, the formation of an S-curve containing the focus error signals is one basis for deciding the existence of a disk in the tray of the optical disk drive.

### BACKGROUND OF INVENTION

1. Field of the Invention

The present invention relates to a method for determining presence of a disk, and more particularly, to a method for determining existence of a disk in an optical disk drive.

2. Description of the Prior Art

There are a numerous categories of disks, such as CD-ROM, CD-R, CD-RW, hybrid CD, single-layer CD, double-layer CD, DVD−R, DVD+R, DVD−RW, DVD+RW, DVD-RAM, and etc. The data formats and physical characteristics of different categories of disks are varied. Hence an optical disk drive needs to be equipped with different utilities for reading data from different categories of disks. For example, the laser wavelength has to be 780 nm in order to read data stored in a CD, or 650 nm in order to read data stored in a DVD. Or the optical disk drive can amplify some designated signals for reading data on some specific categories of disks.

Nowadays it is no longer necessary for consumers to buy separate optical disk drives for different categories of disks. There are already several optical disk drives on the market that support accessing different kinds of disks. For example, a combo optical disk drive provides both functions of CD-RW and DVD-ROM, which means the combo optical disk drive is equipped with both the laser beam for accessing DVDs (650 nm wavelength) and the laser beam for accessing CDs (780 nm wavelength).

However, when the tray is inserted, the combo optical disk drive needs to check if there is a disk on the tray to determine whether to perform the following steps for reading data or not. Generally, the conventional combo optical disk drive only utilizes the laser beam with the 650 nm wavelength for checking the existence of a disk on the inserted tray. Please refer to FIG. 1. FIG. 1 is a flowchart of the prior art method for determining whether a disk is inserted.

Step 100: Focus a 650 nm laser beam;
Step 110: Determine if an S-curve is generated; perform step 120 if an S-curve is generated; otherwise perform step 130;
Step 120: Perform a follow-up process;
Step 130: End.

Please refer to FIG. 2. FIG. 2 is a partial block diagram of the prior art optical disk drive and is utilized to illustrate the operation of focusing in step 100 as follows. A laser diode 1 is capable of generating a laser beam. The laser beam is split by a beam splitter 3. A focus point 9 is generated after the split laser beam is transmitted through an object lens 5. A focus actuator 11 is utilized to control the object lens 5 to move up and down for changing the focal point 9. The laser beam is reflected from a disk 7 and is transmitted back to the beam splitter 3. The beam splitter guides the reflected laser beam to a photo detector 13, and the photo detector 13 generates a signal for providing information about the focus of the laser beam such as a focus error signal or an RF level signal.

Step 110 is a main step for checking the existence of the disk. The generation of an S-curve is determined by The existence of the disk. The different positions of focus points (in the direction of approaching the disk) lead to different focusing error signals, and the focusing error signals together form the S-curve illustrated in FIG. 4.

Please refer to FIG. 3. FIG. 3 is a sectional diagram of a disk 38. Reference number 40 refers to a plastic layer of the disk 38, reference number 42 refers to a first reflection layer, and reference number 44 refers to a second reflection layer of the disk 38. Please refer to FIG. 4, FIG. 4 is a diagram of S-curves. Taking a first reflection layer 42 as an example, when the focus point is away from the disk 38, the reflecting beam is very weak and the focus error signal is very small. When the focus approaches the disk 38 gradually, the focus error signal increases as well, and reaches the maximum value FE_PK1. When the focus moves forward to the first reflection layer 42, the focus error signal decreases, and when the focal point lies on the plane of the surface of the disk, the focus error signal goes to the zero-cross point 52. After the focus error signal reaches the maximum negative value FE_BT1, the signal goes back to zero gradually. An S-curve is generated consequently. It can be seen that after the focus moves through three layers of different material (the plastic layer 40, the first reflection layer 42 and the second reflection layer 44), there will be three S-curves S0, S1 and S2 formed respectively. Therefore, the generation of S-curves can be utilized to determine the insertion of a disk. If there is an S-curve formed, step 120 will be performed, and if not, the determination is ended then.

Furthermore, when a disk is inserted into the optical disk drive, an RF level signal will reach the maximum value when the focus point lies to the plane of the surface of the disk. Therefore, the RF level signal may also be utilized to determine the existence of a disk.

However, in step 100, once the 650 nm laser breaks, the conventional method for determining existence of a disk will fail completely. This causes the combo optical disk drive to be incapable of determining whether a disk is inserted. Therefore, a more efficient way to determine existence of disks is needed.

### SUMMARY OF INVENTION

It is therefore a primary objective of the claimed invention to provide a method for determining existence of a disk in an optical disk drive.

Briefly described, the claimed invention discloses a method for determining existence of a disk in an optical disk drive. The method includes focusing a laser beam of a first wavelength, determining whether a disk is inserted into an optical disk drive according to generation of a predetermined signal, and if the predetermined signal is not generated, focusing a laser beam of a second wavelength.

These and other objectives of the present invention will no doubt become obvious to those of ordinary skill in the art after reading the following detailed description of the preferred embodiment that is illustrated in the various figures and drawings.

### BRIEF DESCRIPTION OF DRAWINGS

FIG. 1 is a flowchart of the prior art method for determining the existence of an optical disk in an optical disk drive.

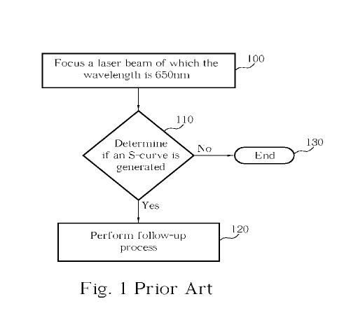

FIG. 2 is a partial block diagram of the prior art optical disk drive.

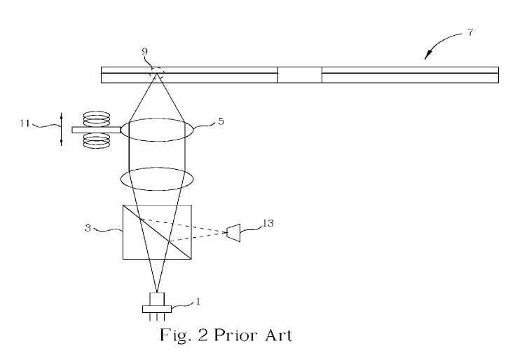

FIG. 3 is a sectional diagram of a disk.

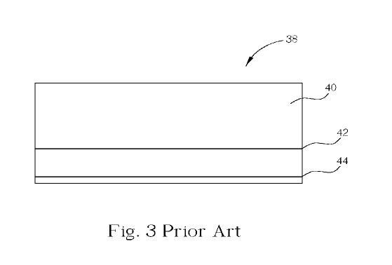

FIG. 4 is a diagram of S-curves.

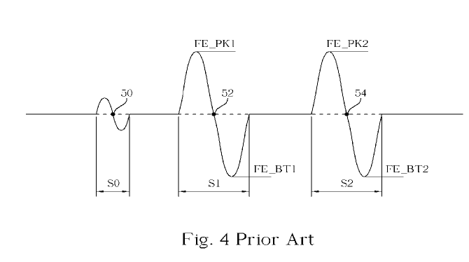

FIG. 5 is a flowchart of the present method for determining the existence of an optical disk in an optical disk drive.

### DETAILED DESCRIPTION

The present invention utilizes the two laser beams of different wavelengths (one for accessing DVDs and another for accessing CDs) emitted from the same pick-up head for improving the accuracy of determining the existence of disks. And the claimed method utilizes a laser beam of another wavelength to increase the correctness of the determination further.

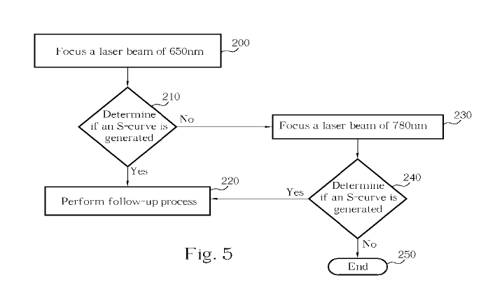

Please refer to FIG. 5. FIG. 5 is a flowchart of the claimed method for determining the insertion of a disk.
Step 200: Focus a laser beam of 650 nm;
Step 210: Determine if an S-curve is generated; perform step 220 if an S-curve is generated; otherwise perform step 230;
Step 220: Perform a follow-up process;
Step 230: Focus a laser beam of 780 nm;
Step 240: Determine if an S-curve is generated; perform step 220 if an S-curve is generated; otherwise perform step 250;
Step 250: End.

The 650 nm laser beam is utilized to access DVDs. When a disk exists in the optical disk drive, by moving the pick-up head up and down for changing the focal point of the laser beam, the focus error signals generated by the photo detector can be gathered and will thereby form an S-curve. Afterwards, step 210 determines if there is an S-curve generated. If there is an S-curve generated, the determination proceeds with step 220. If there is no S-curve generated, step 230 is performed to focus the 780 nm laser beam. The 780 nm laser beam is utilized to access CDs. In step 230, the existence of the disk is rechecked with the same procedure, but using the 780 nm laser beam. The rechecking step improves the accuracy of determination, and solves the blind spot caused by the possibility of the 650 nm laser breaking.

Similarly, if a disk exists in the optical disk drive, the focus error signals will be generated by the photo detector in step 230, and can be gathered to form an S-curve. If an S-curve is generated then, it means it is possible that the 650 nm laser beam breaks so that the existence of the disk is not detected. If there is no S-curve generated, it is determined that there is no disk in the optical disk drive, and the whole determination is finished in step 250.

Basically, the present invention utilizes a 780 nm laser beam to recheck the existence of a disk in an optical disk drive for increasing the accuracy and for preventing the erroneous judgment caused by the 650 nm laser beam breaking. In step 200, the pick-up head can be moved toward the disk for changing the focal point of the 650 nm laser beam. And in step 230, the pick-up head may be moved away from the disk for changing the focal point of the 780 nm laser beam. Besides, the previous embodiment is not a limitation of the present invention. The S-curve is not the only basis of the claimed determination. When a disk is inserted into an optical disk drive, the RF level signal will reach the maximum value when the focal point lies on the plane of the surface of the disk. Therefore, the RF level signal can be utilized to determine the existence of a disk as well.

Furthermore, focusing a laser beam of 780 nm can also be executed if an S-curve is generated from focusing a laser beam of 650 nm for the reason of double check.

The present invention provides a method for determining existence of disks. The claimed method improves the accuracy and prevents the blind spot caused when the 650 nm laser beam breaks.

Those skilled in the art will readily observe that numerous modifications and alterations of the device and method may be made while retaining the teachings of the invention. Accordingly, the above disclosure should be construed as limited only by the metes and bounds of the appended claims.

1. A method for determining existence of a disk in an optical disk drive, the method comprising:
focusing a laser beam of a first wavelength, and determining whether a disk is inserted into an optical disk drive according to generation of a first predetermined signal; and
focusing a laser beam of a second wavelength, and determining whether a disk is inserted into an optical disk drive according to generation of a second predetermined signal.

2. The method of claim 1 wherein the laser beam of the first wavelength and the laser beam of the second wavelength are emitted from an optical pick-up head.

3. The method of claim 2 wherein the step of focusing comprises moving the pick-up head for changing a focal point, and the method further comprises receiving a focus error signal from an photo detector.

4. The method of claim 1 wherein the first predetermined signal is an S-curve or an RF level signal.

5. The method of claim 1 wherein the second predetermined signal is an S-curve or an RF level signal.

6. A method for determining existence of a disk in an optical disk drive, the method comprising:
utilizing a laser beam of a first wavelength to execute focusing and detecting generation of a first predetermined signal
utilizing a laser beam of a second wavelength to execute focusing detecting generation of a second predetermined signal
determining whether a disk is inserted into an optical disk drive according to generation of at least one of the first predetermined signal and the second predetermined signal.

7. The method of claim 7 wherein the laser beam of the first wavelength and the laser beam of the second wavelength are emitted from an optical pick-up head.

8. The method of claim 7 wherein the action of focusing comprises moving the pick-up head for changing a focal point, and the method further comprises receiving a focus error signal from an photo detector.

9. The method of claim 7 wherein the first predetermined signal is an S-curve or an RF level signal.

10. The method of claim 7 wherein the second predetermined signal is an S-curve or an RF level signal.
